(19) United States
(12) Patent Application Publication
(10) Pub. No.: US 2013/0126045 A1
(43) Pub. Date: May 23, 2013

(54) Coping Cut Guide Fixture

(71) Applicant: Jeremy Rubens, Palatine, IL (US)

(72) Inventor: Jeremy Rubens, Palatine, IL (US)

(73) Assignees: ROBERT BOSCH GMBH, Stuttgart (DE); ROBERT BOSCH TOOL CORPORATION, Broadview, IL (US)

(21) Appl. No.: 13/299,428

(22) Filed: Nov. 18, 2011

(51) Int. Cl. B23Q 35/10; B27C 5/10

(52) U.S. Cl. 144/144.52; 144/144.1

(57) ABSTRACT

A coping cut guide fixture includes a base supporting a trim piece with a contour feature oriented along a first axis, and a workpiece engagement arm configured to support the base on the workpiece with the first axis arranged in the direction of the coping cut. A first guide component is slidably mounted on the base for movement parallel to the first axis and a second guide component is slidably mounted on the first guide component for movement perpendicular to the first axis. The second guide component includes a tracing point at one end arranged to follow the contour feature of the trim piece and a tool mount at the opposite end configured to support the coping tool. The second guide component moves with the first guide component so that the coping tool carried by the tool mount follows the contour while making the coping cut.

### FIELD OF THE INVENTION

The present disclosure relates to devices for making coping cuts to fit molding or trim pieces together at inside corners.

### DESCRIPTION OF THE RELATED ART

Coping the inside corner of trim pieces or molding, such as baseboard moldings, chair rails, quarter round, and the like, entails cutting the profile of the molding into the end grain of one of the moldings. The piece that receives the cut, the coped piece, helps push and hold the adjoining piece against the wall and into the corner when the pieces are installed. The result is a well fit corner that will not be affected by expansion and contraction of the wood.

Traditionally, coping cuts are made by hand. To accurately make coping cuts, a skilled woodworker is required, as these cuts require a fairly high skill level. In most cases, this skill level is beyond the “do-it-yourselfer”. Some attempts have been made to simplify or mechanize the process of making coping cuts, typically involving large and expensive duplicating machines that follow a specially-prepared template. The size and weight of these prior devices makes them inconvenient for portable use, such as at a remote job site.

### SUMMARY

In one aspect, a coping cut guide fixture comprises a base supporting a trim piece with a contour feature oriented along a first axis, and a workpiece engagement arm configured to support the base on the workpiece with the first axis arranged in the direction of the coping cut. A first guide component is slidably mounted on the base for movement parallel to the first axis and a second guide component is slidably mounted on the first guide component for movement perpendicular to the first axis.

The second guide component includes a tracing point at one end arranged to follow the contour feature of the trim piece and a tool mount at the opposite end configured to support the coping tool. The first guide component is configured to be moved parallel to the first axis when performing the coping cut. The second guide component moves with the first guide component (parallel to the first axis) and also follows the contour of the trim piece (perpendicular to the first axis) so that the coping tool carried by the tool mount follows the contour while making the coping cut.

### DESCRIPTION OF THE DRAWINGS

FIG. 1 is a perspective view of a coping cut guide fixture according to the present disclosure.

FIG. 2 is a top view of the fixture shown in FIG. 1.

FIG. 3 is a side view of the fixture shown in FIG. 1.

FIG. 4 is a perspective view of a base component of the fixture shown in FIG. 1.

FIG. 5 is a side view of the base shown in FIG. 4.

FIG. 6 is a perspective view of a first guide component of the fixture shown in FIG. 1.

FIG. 7 is a perspective view of a second guide component of the fixture shown in FIG. 1.

FIG. 8 is a side view of the second guide component shown in FIG. 7.

FIG. 9 is an end view of the second guide component shown in FIG. 7.

FIG. 10 is a top view of the fixture shown in FIG. 1 mounted on a workpiece with the first and second guide components in a first position.

FIG. 11 is a top view of the fixture shown in FIG. 1 mounted on a workpiece with the first and second guide components in a second position.

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

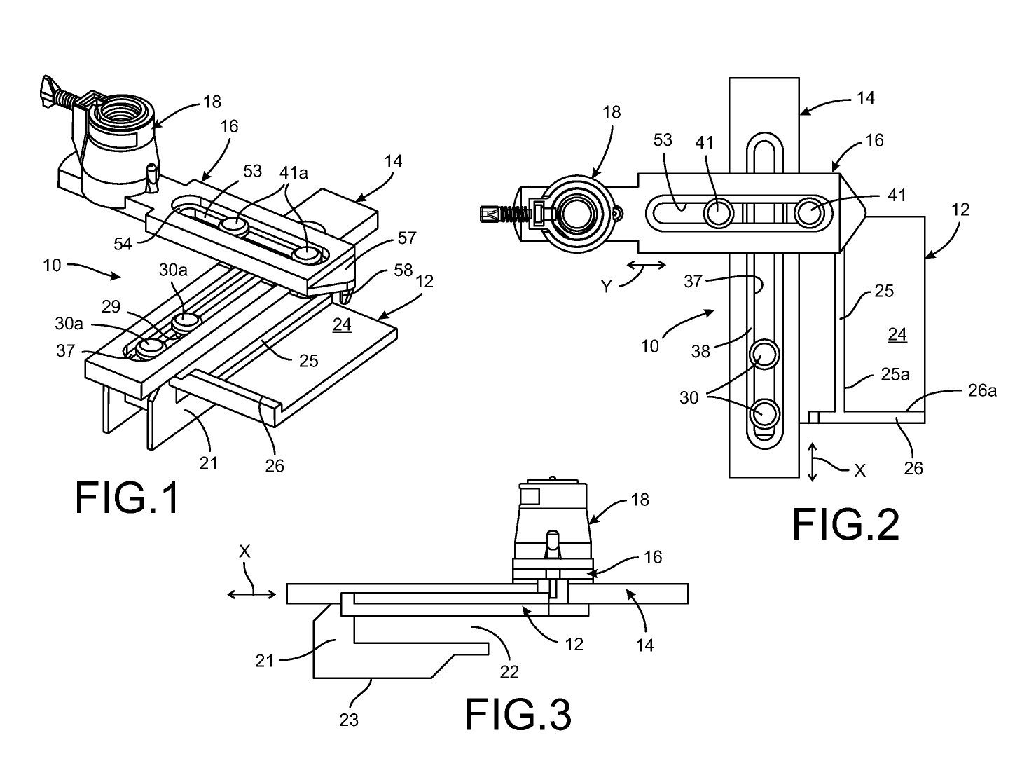

A coping cut guide fixture 10 is depicted in FIGS. 1-3 that is configured to support a coping tool, such as a rotary cutting tool, relative to a workpiece, such as a trim piece or molding. The fixture 10 includes a base 12, a first guide component 14, a second guide component 16 and a tool mount 18. The first guide component 14 is slidably mounted on the base 12 for movement in the direction X, and the second guide component 16 is slidably mounted on the first guide component for movement in the direction Y. The two guide components are in the form of elongated slotted plates. The second guide component 16 supports the tool mount 18 at one end and includes a tracing point 58 at the opposite end. The X and Y directions are preferably orthogonal so that combined movement in the two directions allows the tracing point 58 to follow the curved profile of a trim piece on a particular workpiece, as described in more detail herein.

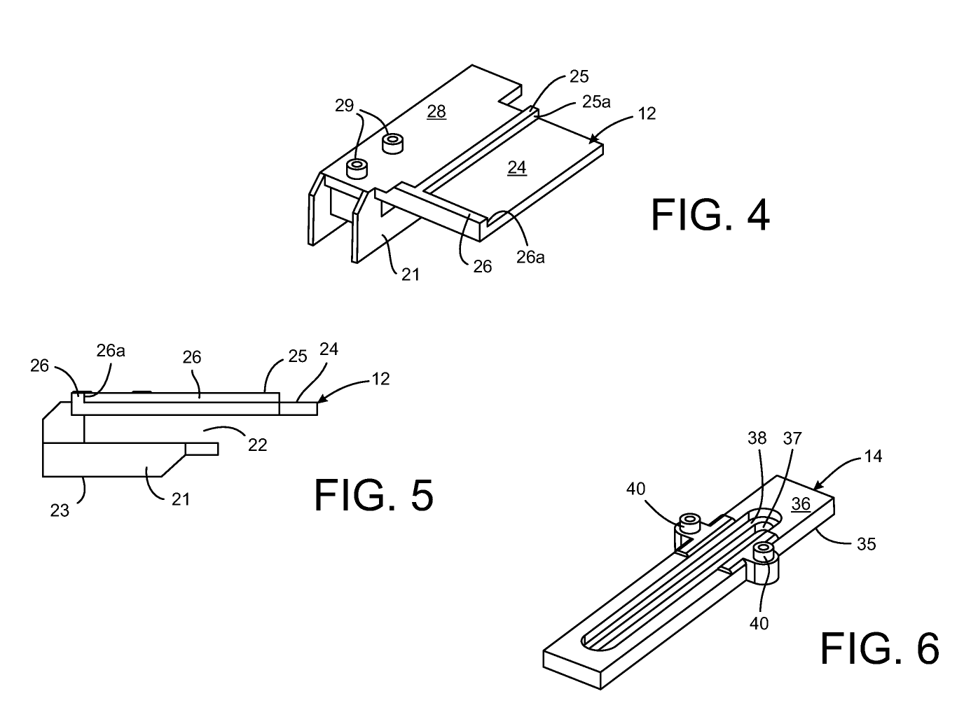

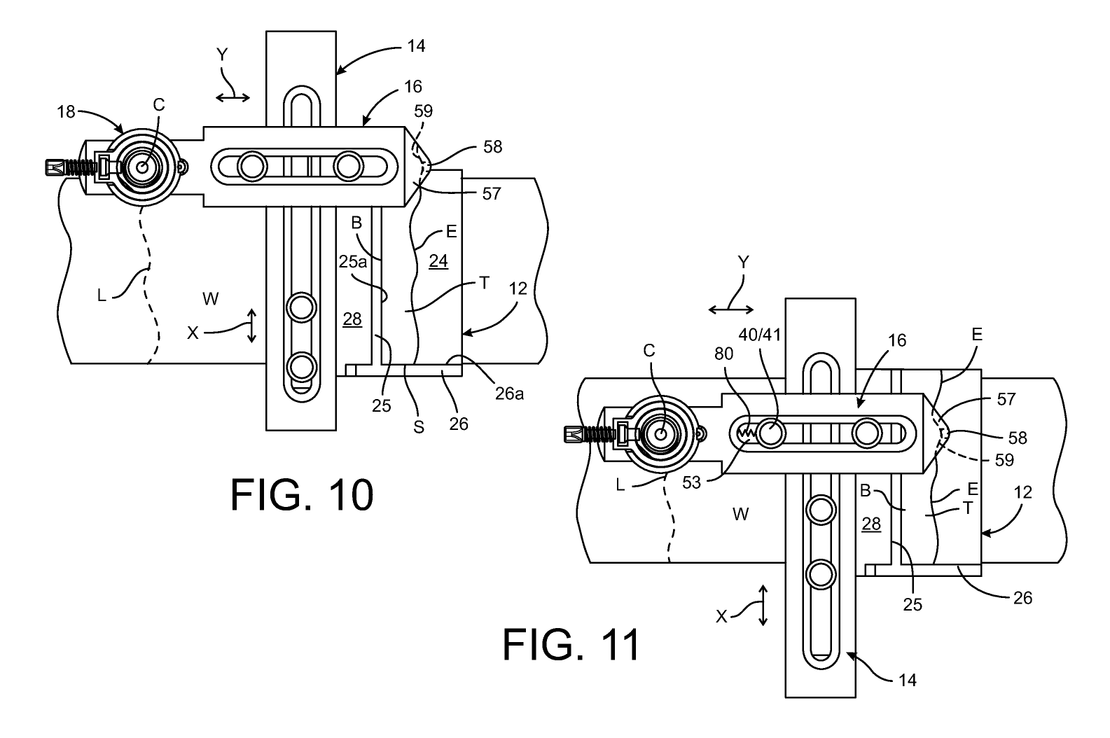

The base 12 of the fixture 10 is configured to support the fixture on a workpiece W as shown in FIGS. 10-11. In one aspect, the base 12 is configured to support the fixture 10 on the workpiece without the need for additional components such as a clamp or other support. Thus, in the disclosed embodiment the base 12 includes a workpiece engagement arm 21 that defines a slot 22, as shown in FIGS. 4-5. The slot 22 may be sized to a standard thickness for trim or molding. The engagement arm 21 may be configured in the form of a clamp constructed of a resilient material to compress the workpiece within the slot 22. Different clamp configurations may be provided with different slot widths to accommodate non-standard thicknesses. adjustable. Alternatively, the engagement arm may be adjustable. In the illustrated embodiment the engagement arm 21 is provided with a generally planar bottom surface 23 so that the fixture 10 may rest on a work surface with a workpiece disposed within the engagement arm.

The base 12 includes a trim piece platform 24 which is a generally planar surface on which the trim piece T to be duplicated rests, as shown in FIG. 10. The trim piece platform is bounded on two sides by stops 25 and 26. The two stops provided respective stop surfaces 25a, 26a against which the trim piece T is abutted, again as shown in FIG. 10. The platform 24 and stops 25, 26 are sized to fully support the trim piece. In one manner of using the fixture 10, the trim piece T is a relatively section of the workpiece W cut from the end of the workpiece. The trim piece is thin enough to sit on the platform 24 and provide clearance for the second guide component 16 to pass over the trim piece. As explained more below, the trim piece is positioned on the platform 24 with the contoured or curved edge E facing away from the stop surface 25a.

The base 12 is a further provided with a guide platform 28 that supports the first guide component 14, as shown in FIGS. 1-2. The guide platform includes a pair of alignment posts 29 projecting upward from the surface of the platform. The alignment posts 29 are sized to seat within the slot 37 of the first guide component 14, as shown in FIG. 1. Corresponding fasteners 30 are configured to engage each alignment post and hold the first guide component in sliding engagement with the guide platform 28. The alignment posts may be threaded bosses and the fasteners machine screws threaded into the bosses, although other configuration so f alignment post and fastener are contemplated that can provide a sliding engagement between the first guide component 14 and the base 12.

Details of the first guide component 14 are shown in FIG. 6. The guide component is in the form of an elongated plate having a lower surface 35 and an opposite upper surface 36. The lower surface may be planar and is configured for sliding contact with the guide platform 28 of the base 12. The upper surface 36 may also be planar and configured for sliding contact with the second guide platform 16. The first guide component 14 defines an elongated slot 37 therethrough, bounded at the upper surface 36 by an annular recess 38. The slot 37 has a width sized to accept the alignment posts 29 but not the head 30a of the fasteners 30. (Alternatively, the fasteners may include a portion that is sized to extend through the slot 37 to engage the alignment posts). The annular recess 38 is sized to accept the head 30a of the fasteners so that the fasteners may be generally recessed within the slot 37 to provide clearance for the second guide component passing over the head of the fasteners. The alignment posts 29 are spaced apart to stabilize the first guide component 14 as it slides in the direction X. In one specific configuration, the alignment posts are separated by a distance equal to about one-fourth the length of the slot 37. While two alignment posts 29 are provided in the illustrated embodiment, other configurations are contemplated that restrict the first guide component to linear travel in the X direction. For instance, a single post may be provided that is elongated in order to prevent twisting of the guide component when the elongated post is seated within the slot 37.

It should be appreciated that the fasteners 30 remain in a fixed position relative to the base 12, while the first guide component 14 is free to slide along the guide platform 28, restrained only by the alignment posts 29 and/or fasteners 30 contacting the ends of the slot 37. The slot 37 has a length sufficient to allow the tool supported by the tool mount 18 to traverse the entire width of the workpiece W as the guide component slides in the X direction. It is contemplated that different guide components 14 may be provided with different slot lengths for differing workpiece widths. It is further contemplated that the length of the slot 37 may be adjusted or a variable position stop may be provided within the slot to adjust the permitted X direction travel of the first guide component 14.

The first guide component 14 includes a pair of carriage posts 40 projecting upward from the top surface 36. The carriage posts 40 may be positioned outboard of the slot 367, as shown in FIG. 6. Fasteners 41 are provided that engage a corresponding post 40, in a manner similar to the post and fastener of the first guide component. Thus, the carriage posts may be threaded bosses and the fasteners machine screws, or any of the other alternatives described above. The carriage post 40 and fasteners 41 are configured to engage the second guide component 16 through the slot 53. While two carriage posts 40 are provided in the illustrated embodiment, other configurations are contemplated that restrict the second guide component to linear travel in the Y direction. For instance, a single post may be provided that is elongated in order to prevent twisting of the guide component when the elongated post is seated within the slot 53.

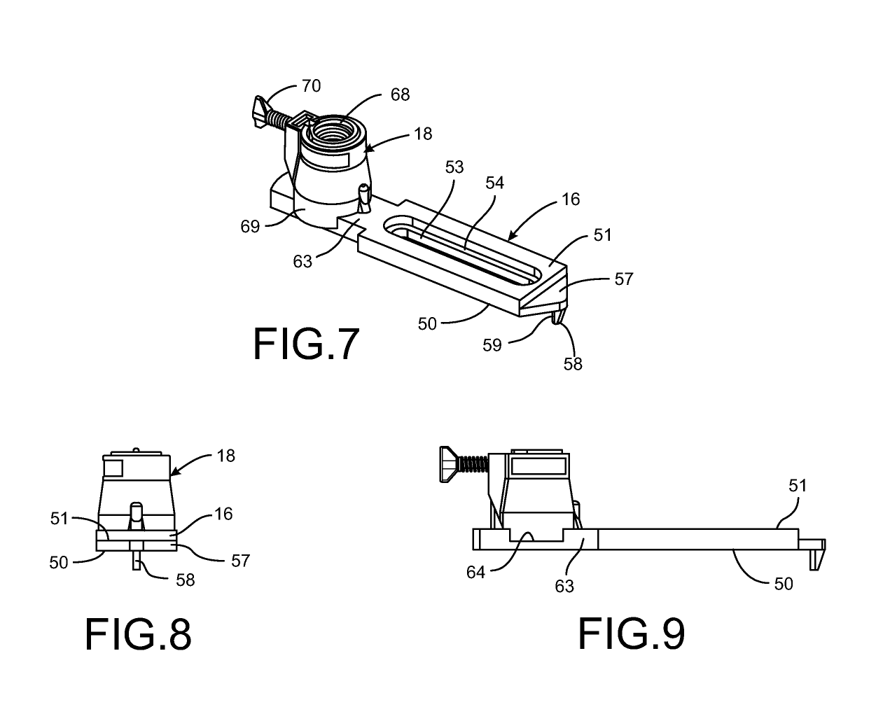

As shown in FIGS. 7-9, the second guide component is also an elongated plate having a bottom surface 50 and opposite top surface 51. The bottom surface 50 may be generally planar and is configured for sliding along the first guide component 14 in the Y direction. The slot 53 includes an annular recess 54, with both features configured like the slot and recess combination 37/38 of the first guide component. In other words, the slot 53 is configured to receive the carriage posts 40 and/or part of the fasteners 41 therethrough, while the head 41a of the fasteners is sized to be seated within the recess 54, preferably below the top surface 51.

The second guide component 16 includes a feature to follow the contour of a trim piece T supported on the base 12, as shown in FIGS. 10-11. Thus, in one aspect the guide component 16 includes an extension 57 that includes a tracing point 58 projecting downward toward the trim piece platform 24, as shown in FIG. 1. The tracing point 58 includes a tracing surface 59 facing the stop surface 25a of the base. The tracing surface thus contacts the contoured or curved edge E of the trim piece T (FIG. 10). The slot 53 has a length sufficient for the tracing point 58 to follow the full contour of a typical trim piece or molding. Thus, in most cases the length of the slot 53 will be less than the length of the slot 37 since the amount of necessary Y direction travel of the tracing point 58 will be less than the amount of X travel necessary to span the width of the workpiece. It is contemplated that different guide components 16 may be provided having different lengths for the slot 53, or that the length or effective length of the slot may be adjustable.

The second guide component 16 further includes a mounting platform 63 that is configured to engage and support the tool mount 18, as shown in FIGS. 7 and 9. The mounting platform may include a mounting feature 64 for mating engagement with a mounting feature 69 on the tool mount 18. In one embodiment, the mounting feature 64 in the guide component 16 includes a recess that receives a locking collar 69 of the tool mount. It is contemplated that the tool mount 18 may be generally permanently affixed to the mounting platform 63, or may be removable so that a pre-existing tool mount or different tool mounts may be used with the coping cut guide fixture 10. The mounting features 64, 69 of the guide component and tool mount may have various elements for firmly locking the tool mount to the guide component. Moreover, the mounting features 64, 69 may incorporate the ability to position the working tool at a non-perpendicular angle relative to the fixture and/or workpiece.

The tool mount 18 may be configured to support various working tools capable of performing a coping cut in a workpiece. In the illustrated embodiment the tool mount 18 is configured to support a tool, such as a rotary tool, like a rotary coping tool or router. The mount may thus include a tool engagement feature 68 and clamping feature 70 adapted for mounting supporting a conventional rotary tool with the tool bit projecting downward from the second guide component 16. It is of course understood that the tool mount 18 is configured so that the tool bit can be extended a sufficient depth to perform the desired coping cut. In most cases the cut will extend through the entire thickness of the workpiece, while in other cases a shallower cut may be desired.

The manner of use for the coping cut guide fixture is illustrated in FIGS. 10-11. The fixture 10 is mounted on a workpiece W with the workpiece disposed within the slot 22 (FIG. 3). The workpiece W is a trim piece or molding having a particular curvature or contour. A trim piece T may be cut from the workpiece to be placed on the platform 24. The trim piece T is cut to a thickness that allows the piece to fit beneath the second guide component 16 so that the guide component can pass freely over the trim piece. As shown in FIG. 10, the trim piece T is placed on the platform 24 with the contoured edge E facing away from the stop 25 and with the flat back face B of the trim piece abutting the stop surface 25a. The side face S abuts the stop surface 26a so that the trim piece T is firmly seated against the stops 25, 26. The fixture 10 may be provided with a clamp or other means for positively retaining the trim piece T in position on the platform 24, provided that it does not interfere with the passage of the tracing point 58 along the edge E of the trim piece T. However, the tracing point 58 will tend to exert a force on the trim piece T holding it against the stop 25 as the first and second guides are translated relative to the edge E.

With the trim piece T on the platform 25, the second guide component 16 is translated in the Y direction until the tracing surface 59 contacts the contoured edge E of the trim piece. The position of the coping tool bit C is aligned over the workpiece W in a position that follows the position of the tracing point 58 on the edge E. The coping tool can be activated to commence the cut along the cut-line L. With the coping tool operating the first guide component 14 is translated along the guide platform 28 in the X direction, such as to the position shown in FIG. 11. It can be appreciated that the tracing point 58 follows the contoured edge E as the first guide component is translated in the X direction, which means that the second guide component 16 translates in the Y direction relative to the first guide component. This Y direction translation moves the coping tool bit C along a parallel path to the contoured edge E so that the cut-line L produces the same contour.

It is contemplated that the operator can manipulate the coping tool supported by the tool mount 18 to cause translation of the first and second guide components 14, 16. The tracing surface 59 can be maintained in contact with the contoured edge E by maintaining pressure on the coping tool in the Y direction away from the stop 25 and downward in the X direction toward the stop 26. With this continuous pressure the coping tool follows the cut-line L in a path parallel to the contoured edge E of the trim piece T. It can be appreciated that the guide fixture 10 disclosed herein allows replication of a wide range of contours or curvatures. Moreover, since the trim piece T is obtained from the workpiece W itself, the cut-line L will identically mimic the contoured edge E, eliminating the errors associated with tracing the edge on the workpiece and performing a free-hand cut.

A biasing element may be provided to bias the coping tool bit C laterally away from the contoured edge E to maintain uniform and continuous contact of the tracing surface with the edge. Thus, in one embodiment a biasing element 80 may be disposed between the outboard end of slot 53 and the carriage post 40 or fastener 41. The biasing element 80 may be a compression spring configured to push the second guide component 16 in the Y direction away from the stop 25. Alternatively the biasing element may be a tension spring disposed between the opposite end of the slot 53 and the inboard post/fastener 40/41, again configured to pull the second guide component in the Y direction away from the stop 25. A similar biasing element may be provided between the first guide component 14 and the base 12 to assist in moving the first guide component, and therefore the coping tool, in the X direction toward the stop 26.

It is contemplated that the coping cut guide fixture 10 may be formed of a plastic material (although the fasteners 30, 41 may be metal). The guide components may be provided with bushings or other components configured to reduce the sliding friction between the base and first guide component and between the first and second guide components. Likewise, the tracing surface 59 may be provided with a component to reduce the sliding friction between the tracing point 58 and the trim piece.

The guide components may be configured to accept trim pieces having different thicknesses. Thus, the carriage posts 40 may be configured to elevate the second guide component 16 a certain distance above the trim piece platform 24 in relation to the thickness of the trim piece supported thereon. Alternatively, the second guide component may be configured so that the end that traverses the trim piece is higher or lower relative to the trim piece platform depending upon the thickness of the trim piece. Similarly, the tracing point may be sized according to the thickness of the trim piece so that the tracing surface can adequately contact the contoured edge E of the trim piece T without scraping on the trim piece platform 24.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A fixture for supporting a coping tool on a workpiece for making a coping cut on the workpiece according to contour feature of an associated trim piece, comprising:
a base having a trim piece platform sized to support the trim piece with the contour feature oriented along a first axis;
a workpiece engagement arm associated with said base and configured to support the base on the workpiece with the first axis arranged in the direction of the coping cut on the workpiece;
a first guide component slidably mounted on said base for movement parallel to said first axis;
a second guide component slidably mounted on said first guide component for movement parallel to a second axis, said second axis perpendicular to said first axis, said second guide component having opposite ends and including a tracing point at one end arranged to follow the contour feature of the trim piece supported on said trim piece platform; and
a tool mount associated with the other opposite end of said second guide component and configured to support the coping tool for making the coping cut in the workpiece.

2. The fixture of claim 1, wherein:
said first guide component includes an elongated first slot; and
said base includes at least one post configured to extend through said first slot and to restrict movement of said first guide component in a direction parallel to said first axis.

3. The fixture of claim 2, in which the trim piece has a width along said first axis and said elongated first slot has a length sufficient to permit movement of said first guide component for a distance at least equal to the width.

4. The fixture of claim 2, wherein said base includes two posts configured to extend through said first slot, said posts spaced apart a sufficient distance to substantially restrict movement of said first guide component in a direction parallel to said first axis.

5. The fixture of claim 2, wherein:
said second guide component includes an elongated second slot; and
said first guide component includes at least one post configured to extend through said second slot and to restrict movement of said second guide component in a direction parallel to said second axis.

6. The fixture of claim 5, wherein said first guide component includes two posts configured to extend through said second slot, said posts spaced apart a sufficient distance to substantially restrict movement of said second guide component in a direction parallel to said second axis.

7. The fixture of claim 1, wherein:
said second guide component includes an elongated second slot; and
said first guide component includes at least one post configured to extend through said second slot and to restrict movement of said second guide component in a direction parallel to said second axis.

8. The fixture of claim 7, wherein said first guide component includes two posts configured to extend through said second slot, said posts spaced apart a sufficient distance to substantially restrict movement of said second guide component in a direction parallel to said second axis.

9. The fixture of claim 1, wherein said base further includes a first stop extending along said trim piece platform parallel to said first axis, said first stop including a first stop surface configured for abutting engagement with the trim piece supported on said trim piece platform.

10. The fixture of claim 9, wherein said base further includes a second stop extending along said trim piece platform perpendicular to said first stop, said second stop including a second stop surface configured for abutting engagement with the trim piece supported on said trim piece platform.

11. The fixture of claim 1, wherein said second guide component is an elongated plate and said tracing point projects below said plate at said one end.

12. The fixture of claim 1, wherein aid base further includes a guide platform that is substantially contiguous with said trim piece platform, said guide platform sized to support said first guide component during movement parallel to said first axis.

13. The fixture of claim 1, wherein said workpiece engagement arm and said base define a slot therebetween sized for engaging the thickness of the workpiece.

14. The fixture of claim 13, wherein said workpiece engagement arm is formed of a resilient material to clamp the workpiece between said engagement arm and said base.

15. The fixture of claim 1, wherein said workpiece engagement arm includes a generally planar surface for supporting said fixture on a work surface.

16. The fixture of claim 1, wherein said second guide component includes a biasing element configured to bias said racing point against the trim piece supported on said trim piece platform.

17. The fixture of claim 16, wherein said biasing element includes a spring disposed between said second guide component and said first guide component.

18. A fixture for supporting a coping tool on a workpiece for making a coping cut on the workpiece according to contour feature of an associated trim piece, comprising:
a base sized to support the trim piece with the contour feature oriented along a first axis;
a workpiece engagement arm associated with said base and configured to support the base on the workpiece with the first axis arranged in the direction of the coping cut on the workpiece;
a first elongated guide component associated with said base and oriented parallel to said first axis;
a second elongated guide component having opposite ends, said second guide component configured at one of said opposite ends to support the coping tool for making the coping cut in the workpiece, and including a tracing point at the other of the opposite ends arranged to follow the contour feature of the trim piece supported on said base; and
a mounting structure between said first and second guide components configured to permit translation of said one of said opposite ends of said second linear guide in directions parallel and perpendicular to said first axis.

19. The fixture of claim 18, wherein:
said first guide component includes an elongated slot; and
said mounting structure includes a pair of alignment posts on said base, said alignment posts configured to extend through said slot and arranged to permit movement of said first guide component relative to said base in a direction parallel to said first axis.

20. The fixture of claim 18, wherein:
said second guide component includes an elongated slot; and
said mounting structure includes a pair of posts on said first guide component, said posts configured to extend through said slot and arranged to permit movement of said second guide component relative to said base in a direction perpendicular to said first axis.
